(19) United States
(12) Patent Application Publication
(10) Pub. No.: US 2007/0187244 A1
(43) Pub. Date: Aug. 16, 2007

(54) Composite Membrane To Capture Analyte Transfers From Gels

(75) Inventors: Mingde Zhu, Hercules, CA (US); Richard P. Moerschell, Concord, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD Laboratories, Inc., Hercules, CA (US)

(21) Appl. No.: 11/608,932

(22) Filed: Dec. 11, 2006

Related U.S. Application Data
(60) Provisional application No. 60/750,254, filed on Dec. 13, 2005.

(51) Int. Cl. B01D 61/42; G01N 27/00

(52) U.S. Cl. 204/464; 204/614

(57) ABSTRACT

Proteins and other analytes that have been separated by electrophoretic means in a gel are transferred to a membrane by conventional blotting techniques, the membrane being a composite of an analyte binding layer and a size retention layer. The pore size of the size retention layer is large enough to allow non-macromolecular ions to pass, yet not large enough to allow the passage of the analytes from the gel, nor antibodies or other macromolecules or reagents in general that might be used in the detection, imaging, or quantification of the analytes.

### CROSS-REFERENCE TO RELATED APPLICATION

This application claims benefit from U.S. Provisional Patent Application No. 60/750,254, filed Dec. 13, 2005, the contents of which are incorporated herein by reference in their entirety.

### BACKGROUND OF THE INVENTION

1. Field of the Invention

This invention resides in the field of analytical materials for the identification of biological species, and is of particular interest in regard to membranes to which biological species are transferred following their electrophoretic separation in a gel.

2. Description of the Prior Art

The transfer of electrophoretically separated analytes from a gel to a membrane for purposes of labeling, staining, or any procedure in general that is used for detection, identification and, in some cases, quantification of the analytes, is referred to in the biotechnology industry as “blotting.” One of the most common types of blotting is “Western blotting,” also known as immunoblotting, a routine technique for protein analysis in which the proteins are transferred to the membrane and the membrane then exposed to an antibody under conditions allowing the proteins and antibody to combine by antigen-antibody binding. The detection of bound antibody, and hence protein, is then achieved by labeling, either on the antibody itself or by the subsequent application of labels or further binding members that are themselves labeled. The typical label is an enzyme bonded directly to the antibody and detectable by exposure to an appropriate substrate, the interaction producing a chemiluminescent, chromogenic or fluorogenic product that can be detected by film, a CCD camera, or any appropriate imager. Specific proteins in a complex mixture can be identified in this manner and both qualitative and semi-quantitative data pertaining to each protein can be obtained. Following the binding of the proteins but before any further steps are performed, the membrane is treated with a blocking agent to block all binding sites that have not been consumed by the proteins, thereby restricting the subsequent binding interactions to the immobilized proteins themselves and eliminating background noise. The procedure is also applicable to analytes other than proteins, such as for example, peptides, nucleic acids, and carbohydrates.

The most commonly used blotting membranes are those made of nitrocellulose, poly(vinylidene fluoride) (PVDF), and nylon. Methods by which the analytes are transferred from the gel to the membrane include diffusion transfer, capillary transfer, heat-accelerated convectional transfer, vacuum blotting transfer, and electroelution. The most common is electroelution, which is achieved by placing the analyte-containing gel in direct contact with the membrane, then placing the gel and membrane between two electrodes submerged in a conducting solution and applying an electric potential between the electrodes. The transfer results from the electrophoretic mobility of the analytes, and the resulting array of analytes on the membrane is a copy of their arrangement in the gel.

To receive analytes from the gel, particularly when the transfer is performed by electroelution, the membrane must be porous to allow the passage of ions in response to the electric potential. The typical membrane therefore has pores with diameters in the range of from about 0.1 μm to about 0.4 μm. In certain procedures, unfortunately, pores of this size are large enough to allow some of the analytes, particularly proteins and nucleic acids, to pass through the membrane before the analytes can bind to the membrane. Other analytes will be retained by the membrane but will bind within the bulk of the membrane rather than on the membrane surface. Analytes that have passed through the membrane are entirely lost to the procedure and cannot be detected, while those attach to the membrane within the bulk of the membrane rather than at its surface are less accessible both to the assay reagents subsequently applied and to the imaging components. The passing of analytes beyond the membrane surface limits the effectiveness of blotting as a means for a quantitative analysis.

One means of reducing the loss of analytes is described in Coull, J. M., et al. (Millipore Corporation), U.S. Pat. No. 5,011,861, entitled “Membranes for Solid Phase Protein Sequencing,” issued Apr. 30, 1991, wherein membranes are derivatized with diisothiocyanate groups to achieve increased blotting and sequencing efficiencies. Another means of reducing the loss of analytes is to crosslink the membrane, or to crosslink the analyte to the membrane, after the analyte has been transferred. This method is disclosed by Pappin, D. J. C., et al. (Millipore Corporation), U.S. Pat. No. 5,071,909, entitled “Immobilization of Proteins and Peptides on Insoluble Supports,” issued Dec. 10, 1991. A further description of treatments of membranes, although by addressing the problem of background noise, is found in Salinaro, R. F. (Pall Corporation), U.S. Pat. No. 5,567,626, entitled “Method of Detecting Biological Materials Using a Polyvinylidene Fluoride Membrane,” issued Oct. 22, 1996, wherein the membrane is heated to 80-160° C. for 32 hours or more prior to contact with the analytes or the detecting reagents to decrease the surface area of the membrane and thereby decrease the ease by which the detecting reagents can bind to the membrane.

### SUMMARY OF THE INVENTION

The problems of background noise, incomplete analyte binding, and other limitations of the prior art are addressed by the present invention, which resides in a composite membrane that includes an analyte binding layer and a size retention layer bonded together. In use, the composite membrane is arranged such that the analyte binding layer faces the gel and is positioned between the gel and the size retention layer. The analyte binding layer is occasionally referred to herein for convenience as a “protein binding layer” since proteins are an illustrative and commonly used analyte to which the present invention is particularly useful. Nevertheless, materials that bind biological analytes other than proteins can likewise be used to a corresponding effect. The analyte binding layer in composites of this invention is a thin layer, preferably about 1 μm to about 150 μm in thickness, and is of a conventional binding material. For proteins, as noted above, the material will be nitrocellulose, PVDF, or nylon. These materials are also useful for nucleic acids, and further materials for other analytes will be apparent to those skilled in the art. The size retention layer is a material that is preferably chemically inert to the analytes as well as the assay reagents, in addition to its ability to prevent passage of the analytes. The functional characteristic of the size retention layer in this invention is its molecular weight cut-off (MWCO), and materials with an appropriate MWCO can be selected to serve the needs of the particular assay to be performed. Further details regarding these and other features of the invention will be apparent from the descriptions that follow.

### BRIEF DESCRIPTION OF THE DRAWINGS

FIG. 1 is a cross section of a composite membrane in accordance with the present invention.

FIG. 2 is a cross section of another composite membrane in accordance with the present invention.

FIG. 3a is a cross section of the composite membrane of FIG. 1 in contact with a gel and electrodes prior to, or at the start of, the transfer of proteins from the gel to the composite membrane.

FIG. 3b is a cross section of the components of FIG. 3a upon completion of the transfer of proteins to the membrane.

### DETAILED DESCRIPTION OF THE INVENTION AND PREFERRED EMBODIMENTS

The terms “a” and “an” are intended to mean “one or more.” The term “comprise,” and variations thereof such as “comprises” and “comprising,” when preceding the recitation of a step or an element is intended to mean that the addition of further steps or elements is optional and not excluded. All patents, patent applications, and other published reference materials cited in this specification are hereby incorporated herein by reference in their entirety. Any discrepancy between any reference material cited herein and an explicit teaching of this specification is intended to be resolved in favor of the teaching in this specification. This includes any discrepancy between an art-recognized definition of a word or phrase and a definition explicitly provided in this specification of the same word or phrase.

The analyte binding layer is a material that immobilizes the analytes (i.e., proteins, nucleic acids, or other biological species that have been separated in the gel) by non-covalent binding, but rather primarily by a hydrophobic attraction, a weak coulombic attraction or a combination of hydrophobic and coulombic attractions. As noted above, examples of binding layer materials are nitrocellulose, PVDF, and nylon. Derivatized forms of these materials, as known among those skilled in the art, can be used as well. Of the examples listed above, nitrocellulose and PVDF are preferred, and nitrocellulose is the most preferred. The analyte binding capacity of the layer can vary widely, depending on the choice of materials. In general, the binding capacity will fall within the range of about 5 μg/cm² (micrograms of analyte per square centimeter of binding layer surface) to about 170 μg/cm², and preferably from about 50 μg/cm² to about 150 μg/cm². The analyte binding occurs primarily at the surface of the layer, although a certain amount of analyte can be expected to migrate into the bulk of the layer. To maintain high accessibility of the assay reagents to all analytes bound to the layer, the layer is preferably thin, particularly since structural stability of the binding layer can be maintained by attachment of the binding layer to the size retention layer which may itself be supported by an additional support layer. As noted above, a preferred thickness range for the analyte binding layer is about 1 μm to about 150 μm, and most preferred thicknesses are in the range of about 10 μm to about 50 μm.

The size retention layer is a material that provides support for the analyte binding layer, that can bond to the binding layer, and that has pores large enough to permit the passage of the ions present in the typical buffer solution during electroelution and yet small enough to prevent the passage of the analytes, i.e., the proteins, nucleic acids, or other species being detected. In most cases, these results will be achieved with a layer having a MWCO within the range of from about 0.3 kD (kilodaltons) to about 10 kD, and preferably within the range of from about 0.5 kD to about 5 kD. The thickness of the size retention layer is less significant than its MWCO for purposes of this invention, and may vary widely. In most cases, an appropriate thickness will be less than 1 mm, or from about 100 μm to about 1 mm, or preferably from about 200 μm to about 500 μm. The chemical composition of the size retention layer can vary widely and is not critical other than to be able to support and bond to the analyte binding layer and to form pores of the appropriate size. Examples of suitable materials for use as the size retention layer are those used in filtration units, notably centrifuigal filtration units. Materials known for this type of use include nitrocellulose (when not used in the analyte binding layer), cellulose acetate, polysulphones including polyethersulphone and polyarylsulphones, polyvinylidene fluoride, polyolefins including ultrahigh molecular weight polyethylene, low density polyethylene and polypropylene, nylon and other polyamides, poly(tetrafluoroethylene) (PTFE), thermoplastic fluorinated polymers such as poly((tetrafluoroethylene)-co-perfluoro(alkyl vinyl ether)) (poly (TFE-co-PFAVE)), and polycarbonates.

Certain materials are listed under both the analyte binding layer and the size retention layer. When the two layers are of the same material, the two will differ by their pore sizes, the size retention layer having the smaller pore size. Preferably, the two layers are of different materials.

In accordance with this invention, the analyte binding layer will be bonded to the size retention layer, rather than having been prepared separately and then layered over or pressed against the analyte binding layer. The bonding of the two layers to each other prevents lateral migration of the analytes at the interface between the two layers. The bonding can be non-specific, non-covalent bonding or covalent coupling. For non-specific bonding, the protein retention layer can be applied as a liquid solution to the solid pre-formed size retention layer followed by evaporation of the solvent from the liquid solution. When nitrocellulose is used as the analyte binding layer, examples of solvents that can serve this function effectively are low molecular weight alcohols, specific examples of which are methanol, ethanol, and isopropanol. Methanol is preferred for convenience of use. Covalent coupling can also be achieved by conventional means. Common linking agents can be used, examples of which are epoxides and 1-ethyl-3-(3-dimethylaminopropyl)carbodiimide (EDAC) which links carboxyl groups on one of the layers to primary amines on the other. If such groups are not native to the layers, the layers are readily derivatized by known methods to contain such groups. Other coupling and crosslinking agents, known in the art, can likewise be used.

Alternatively, the analyte binding layer can be attached to the size retention layer by an adhesive. This allows the use of a size retention layer that is removable, particularly one that can be peeled off, exposing proteins or other analytes that have become bound to the side of the binding layer facing the retention layer.

Further layers are included in certain composite membranes of the invention, serving purposes such as added support for the analyte binding and retention layers. A support layer if present will be on the outer side of the size retention layer, on the side opposite that to which the binding layer is bonded, and the support layer need not be bonded to the size retention layer. Coated layers can also be used, with coatings that facilitate the bonding of the analyte binding layer to the retention layer. Such additional layers and coatings are known in the art.

Once formed, the composite membrane of the present invention is useful in blotting and identification procedures, including Western blotting and other such procedures. The operative steps in the procedures are the same as those used in prior art blotting and identification procedures.

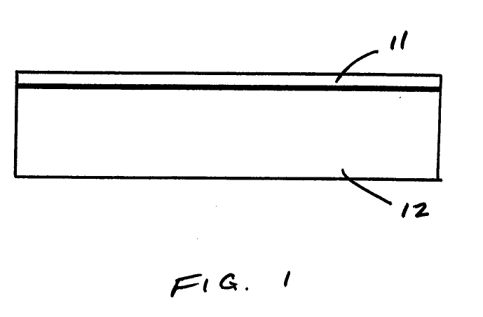

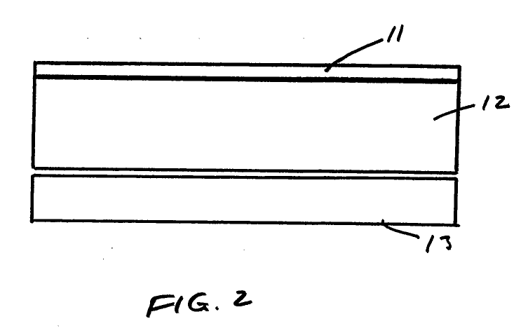

An example of a composite membrane is shown in FIG. 1. The upper layer in this depiction is a protein binding layer 11 and the lower layer is a size retention layer 12. In this particular embodiment, the protein binding layer 11 is 10 μm in thickness and the size retention layer 12 is 100 μm in thickness. Another example appears in FIG. 2, in which a third layer 13 is added. As noted above, this third layer can be a support layer adding structural rigidity or integrity to the composite membrane.

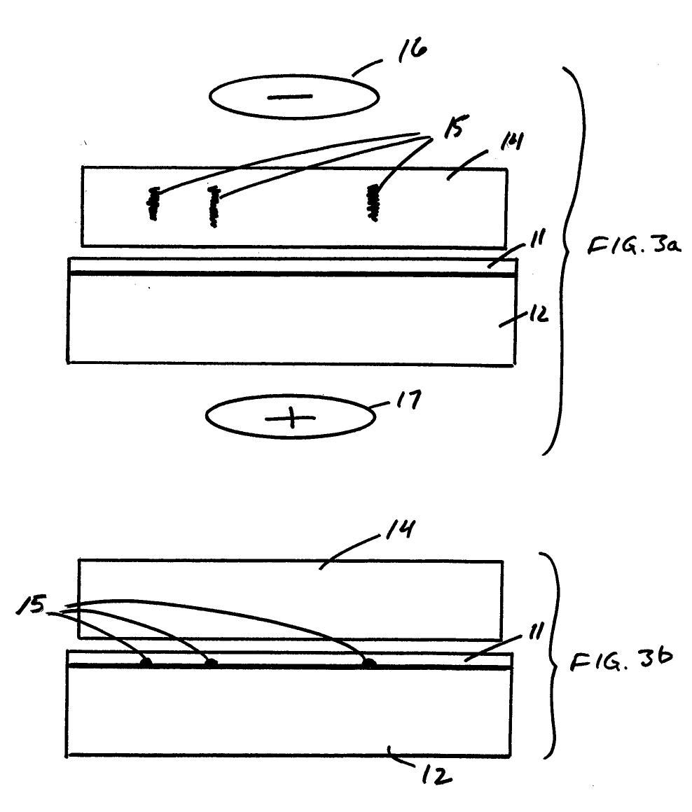

The composite membrane of FIG. 1 is shown in use in FIGS. 3a and 3b. The exposed surface of the protein binding layer 11 is placed in contact with a gel 14 containing a two-dimensional array of protein bands or spots 15. (The gel 14 and composite membrane 11, 12 are shown separated in the drawing for clarity but in use will be in full contact.) The gel and composite membrane are then placed between a cathode 16 and an anode 17, and an electric potential is applied between these electrodes and through the gel and membrane. The result of the potential is shown in FIG. 3b in which the proteins 15 have migrated to the binding layer 11 and their migration has been stopped by the size retention layer 12. FIGS. 1, 2, 3a, and 3b are not drawn to scale.

Further variations and embodiments will be apparent to those skilled in the art of electroblotting who have studied the drawings hereto and descriptions offered above. Different materials, dimensions, and configurations, as well as operating conditions, all within the scope of this invention will be readily apparent to the skilled chemist and biochemist.

What is claimed is:

1. A composite membrane for use in transferring electrophoretically separated analytes in a gel to a membrane to which said analytes bind upon contact, said composite membrane comprising an analyte binding layer and a size retention layer bonded to each other, said analyte binding layer being of a material that binds to said analytes upon contact and said size retention layer being of a material that prevents passage of molecules whose minimum molecular weight is from about 0.3 kD to about 10 kD.

2. The composite membrane of claim 1 wherein said size retention layer is of a material that prevents passage of molecules whose minimum molecular weight is from about 0.5 kD to about 5 kD.

3. The composite membrane of claim 1 wherein said analyte binding layer has an analyte binding capacity of from about 5 μg/cm² to about 170 μg/cm².

4. The composite membrane of claim 1 wherein said analyte binding layer has an analyte binding capacity of from about 50 μg/cm² to about 150 μg/cm².

5. The composite membrane of claim 1 wherein said analyte binding layer is from about 1 μm to about 150 μm in thickness, and said size retention layer is from about 100 μm to about 1 mm in thickness.

6. The composite membrane of claim 1 wherein said analyte binding layer is from about 10 μm to about 50 μm in thickness, and said size retention layer is from about 200 μm to about 500 μm in thickness.

7. The composite membrane of claim 1 wherein said analyte binding layer and said size retention layer are bonded to each other by non-specific, non-covalent bonding.

8. The composite membrane of claim 1 wherein said analyte binding layer and said size retention layer are bonded to each other by covalent bonding.

9. The composite membrane of claim 1 wherein said analyte binding layer is a member selected from the group consisting of nitrocellulose, poly(vinylidene fluoride), and nylon, and said size retention layer is a member selected from the group consisting of nitrocellulose, cellulose acetate, a polysulphone, poly(vinylidene fluoride), polyolefins, a polyamide, poly(tetrafluoroethylene), a thermoplastic fluorinated polymer, and a polycarbonate.

10. The composite membrane of claim 1 wherein said analyte binding layer is a member selected from the group consisting of nitrocellulose and poly(vinylidene fluoride), and said size retention layer is a member selected from the group consisting of nitrocellulose, cellulose acetate, a polyethersulphone, a polyarylsulphone, poly(vinylidene fluoride), an ultrahigh molecular weight polyethylene, low density polyethylene, polypropylene, nylon, poly(tetrafluoroethylene), poly((tetrafluoroethylene)-co-perfluoro(alkyl vinyl ether)), and a polycarbonate.

11. A method for transferring electrophoretically separated analytes in a gel to a membrane to which said analytes bind upon contact, said method comprising transferring said analytes to a composite membrane comprising an analyte binding layer and a size retention layer bonded to each other, said analyte binding layer being of a material that binds to said analytes upon contact and said size retention layer being of a material that prevents passage of molecules whose minimum molecular weight is from about 0.3 kD to about 10 kD.

12. The method of claim 11 comprising transferring said analytes to said composite membrane by electroelution.

13. The method of claim 11 wherein said size retention layer is of a material that prevents passage of molecules whose minimum molecular weight is from about 0.5 kD to about 5 kD.

14. The method of claim 11 wherein said analyte binding layer has an analyte binding capacity of from about 5 μg/cm² to about 170 μg/cm².

15. The method of claim 11 wherein said analyte binding layer has an analyte binding capacity of from about 50 μg/cm² to about 150 μg/cm².

16. The method of claim 11 wherein said analyte binding layer is from about 1 μm to about 150 μm in thickness, and said size retention layer is from about 100 μm to about 1 mm in thickness.

17. The method of claim 11 wherein said analyte binding layer is from about 10 μm to about 50 μm in thickness, and said size retention layer is from about 200 μm to about 500 μm in thickness.

18. The method of claim 11 wherein said analyte binding layer and said size retention layer are bonded to each other by non-specific, non-covalent bonding.

19. The method of claim 11 wherein said analyte binding layer and said size retention layer are bonded to each other by covalent bonding.

20. The method of claim 11 wherein said analyte binding layer is a member selected from the group consisting of nitrocellulose, poly(vinylidene fluoride), and nylon, and said size retention layer is a member selected from the group consisting of nitrocellulose, cellulose acetate, a polysulphone, poly(vinylidene fluoride), polyolefins, a polyamide, poly(tetrafluoroethylene), a thermoplastic fluorinated polymer, and a polycarbonate.

21. The method of claim 11 wherein said analyte binding layer is a member selected from the group consisting of nitrocellulose and poly(vinylidene fluoride), and said size retention layer is a member selected from the group consisting of nitrocellulose, cellulose acetate, a polyethersulphone, a polyarylsulphone, poly(vinylidene fluoride), an ultrahigh molecular weight polyethylene, low density polyethylene, polypropylene, nylon, poly(tetrafluoroethylene), poly((tetrafluoroethylene)-co-perfluoro(alkyl vinyl ether)), and a polycarbonate.
